(19) United States
(12) Patent Application Publication
(10) Pub. No.: US 2008/0301717 A1
(43) Pub. Date: Dec. 4, 2008

(54) VISUALIZING A MEMORY FOOTPRINT OF AN APPLICATION PROGRAM

(75) Inventors: Trishul A. M. Chilimbi, Seattle, WA (US); George G. Robertson, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/756,395

(22) Filed: May 31, 2007

(51) Int. Cl. G06F 3/00

(52) U.S. Cl. 719/329

(57) ABSTRACT

A memory footprint interface visibly displays one or more memory footprints of an application program during a selected time interval. In one implementation, the memory footprint interface receives one or more application program address traces, which include data regarding minimum and maximum memory addresses that are being accessed during execution of the program in the selected time interval. The memory footprint interface can animate playback of memory address reference with various timed fadeout, so as to indicate memory reuse or working set size. The memory footprint interface can also then provide a number of visible indicia for the corresponding memory access patterns over the particular time interval. The visible indicia can be used to color code a wide range of data items displayed through the memory footprint interface, so as to differentiate such things as read and/or write access requests, frequency, threads, and so forth.

### CROSS-REFERENCE TO RELATED APPLICATIONS

N/A

### BACKGROUND

### 1. Background and Relevant Art

As computerized systems have increased in popularity, so have the complexity of the software and hardware employed within such systems. In general, there are a number of reasons that drive software and hardware changes for computerized systems. For example, as hardware capabilities improve, software often needs to change to accommodate new hardware requirements. Similarly, as software becomes more demanding, a similar effect occurs that can push hardware capabilities into new ground. In addition to these reciprocating push forces, end-users continue to demand that software and hardware add convenience by improving automation of certain tasks or features, or by adding automation where none previously existed.

For at least these reasons, software is continually being developed. In some cases, new software programs are written entirely from scratch, while in other cases, some software programs continue through ongoing, incremental updates. Developing software, however, is not a simple matter. In particular, software development typically involves not only the creation of executable code, but also extensive testing techniques to ensure that the executable code works properly. In this regard, there are a variety of metrics and considerations that can be used to gauge whether a program works as intended, or in accordance with certain hardware and software expectations.

One such consideration is the basic level of input/output operation, where an executable computer program simply provides certain expected outputs in response to certain inputs. For example, a tester might want to determine if a particular user interface of an application program displays certain data or results in response to certain provided inputs. Other considerations in software testing can include how well the given application programs allocate or use resources during execution of certain functions. That is, beyond whether an application program actually performs a particular function, a tester might be interested to see if the application program was well-written, in that it does not tax a computer's resources any more than it needs to with certain executions.

One example of this is the consideration referred to herein of “memory locality,” which is also sometimes referred to as “locality of reference,” or more simply as “locality.” In general, locality refers at least partly to the notion that more frequently accessed data items should be fetched into cache memory. Cache memory, in turn, tends to be much faster than main memory, which is where the application program and data is otherwise loaded during execution. Along these lines, locality also refers at least partly to the notion that sequentially-accessed data items should be brought into cache memory together, or at least in sequence, since it is faster to read items already in cache rather than continually pull them in from outside of cache. Thus an application program can be optimized for speed often by improving locality (i.e., sequential accessibility) of its data items (i.e., functions, information, etc.)

In general, one way that application programs can improve efficiency through optimizing locality is by referencing data items in main memory so that data items that are needed in sequence are stored together in cache. This is particularly the case since memory items are typically pulled into cache memory in “chunks” (ranges of addresses). That is, data items in neighboring memory addresses are pulled into cache memory at the same time as the targeted data items are pulled into cache memory. Well-written application programs can thus be configured to ensure that frequently and sequentially accessed data items are pulled into cache memory together, so that they can be executed in cache memory without interruption.

One can appreciate, therefore, that arranging data references in memory poorly can result in less-efficient execution. This can occur when the result is that sequentially-accessed data items are not arranged near or next to each other, and/or are otherwise pulled into cache memory in different, non-sequential chunks. Specifically, poor memory reference locality leads to more costly paging and caching behavior (i.e., more page faults and more cache faults). Accordingly, developers will often endeavor to optimize locality considerations when writing or developing code.

Unfortunately, current hardware specifications and developments have made such memory locality optimizations increasingly more difficult. For example, the memory system behavior of present software is typically determined by a complex set of factors that include code size, program data structures used, mapping of code and data to memory addresses, how the memory addresses are accessed, and architectural considerations, such as cache and memory configuration. Current tools generally do not make it easy for an average programmer to understand whether his/her software has a reference locality problem or not, or to identify problem areas in the code or data structures used. Consequently, programmers have very little idea of a program's memory systems behavior, and often write programs with poor memory reference locality.

It is not surprising therefore, that a program's memory system performance is often the main determinant of its overall performance, particularly in light of the large performance gap between processor speeds and memory and disk access times.

### BRIEF SUMMARY

Implementations of the present invention provide systems, methods, and computer program products configured to visibly represent an application program's memory footprint (i.e., memory locality, or reference locality). In at least one implementation, for example, a memory footprint user interface is configured to receive one or more memory address traces of an application program. The address traces include data regarding minimum and maximum memory addresses that are being accessed during execution of the application program. The memory footprint user interface can then provide a number of visible indicia for the given trace, where the indicia show memory accesses during application program execution. The memory footprint user interface can be adjusted with a number of different configurations and/or filters to display the memory access patterns, and to show the underlying code (or other information) for a particular memory access.

For example, a method of visually representing a memory footprint of the application program can involve identifying a time interval during which an application program executes a plurality of memory accesses. The method can also involve creating one or more address traces for the application program during the identified time interval. In addition, the method can involve generating pixel information corresponding to the memory accesses of the one or more memory address traces, where the memory accesses can be displayed in accordance with the identified time interval. Furthermore, the method can involve visibly displaying in a display window the pixel information in accordance with one or more filtration selections by the user, wherein the display of pixels indicate a memory access footprint for the application program during the selected time interval.

In addition, a user interface configured to visually represent a memory footprint of the application program can include a display window for viewing a memory footprint over a selected time interval. The user interface can also include a set of one or more memory controls configured to adjust the number of memory words, a range of the cache line, a page size, or a number of disk blocks displayed per sample. In addition, the user interface can include a set of one or more playback controls configured to display a plurality of different application program execution samples during the selected time interval. Furthermore, the user interface can include a plurality of selectable option controls configured to filter display of the application program execution during the selected time interval.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an overview schematic diagram of a system for displaying memory footprint information in accordance with an implementation of the present invention;

FIG. 2A illustrates one implementation of a memory footprint user interface in accordance with the present invention;

FIG. 2B illustrates a dialog box used to import a trace in accordance with an implementation of the present invention;

FIG. 2C illustrates the memory footprint user interface of FIG. 2A after displaying the first few intervals of memory accesses by an application program;

FIG. 2D illustrates the memory footprint user interface of FIG. 2C after displaying the next few intervals of memory accesses by the application program;

FIG. 2E illustrates the memory footprint user interface of FIG. 2D after displaying all of the memory accesses by the application program during the entire time interval, and further upon zooming in more closely on some of the memory access in the memory heap;

FIG. 2F illustrates the memory footprint user interface of FIG. 2A after having displayed a memory footprint of an application program that is optimized in its memory accesses;

FIG. 3 illustrates a user interface that is selectable from the memory footprint user interface, and can be used to further refine how memory accesses are displayed; and

FIG. 4 illustrates a flowchart of a series of acts in a method for visually displaying a memory footprint of an application program in accordance with an implementation of the present invention.

### DETAILED DESCRIPTION

Implementations of the present invention extend to systems, methods, and computer program products configured to visibly represent an application program's memory footprint (i.e., memory locality, or reference locality). In at least one implementation, for example, a memory footprint user interface is configured to receive one or more memory address traces of an application program. The address traces include data regarding minimum and maximum memory addresses that are being accessed during execution of the application program. The memory footprint user interface can then provide a number of visible indicia for the given trace, where the indicia show memory accesses during application program execution. The memory footprint user interface can be adjusted with a number of different configurations and/or filters to display the memory access patterns, and to show the underlying code (or other information) for a particular memory access.

Accordingly, and as will be understood more fully from the following specification and claims, implementations of the present invention can provide a wide range of advantages for optimizing memory accesses by an application program. In at least one implementation, this can be done via one or more tools that provide effective memory usage visualizations. In particular, the one or more tools can be configured to animate memory access and instruction-addressed trace information over a time interval of application program execution.

These visualizations and/or animations, in turn, can allow a programmer to quickly learn the total memory footprint of a program. These visualizations and/or animations can indicate to a developer/programmer how memory is being (or not being) reused, the size of what the dynamic working set is over time, and data access patterns (e.g., linear scans, sequential strides, cyclic patterns, etc.) As a result, a developer/programmer can identify problem areas in poorly behaving code and data structures more easily.

In general, the tool in accordance with at least one implementation of the present invention has essentially three modes of operation. At least one mode of operation emphasizes reuse of memory, while another emphasizes the working set over time, and yet another emphasizes the total memory footprint of the application program. In each case, and as discussed more fully herein, a region of display space is used to represent the total range of memory addresses touched by the given application program. In particular, each memory access highlights a region of the display, where by each pixel represents an amount of words of memory. In one implementation, the mapping of pixel(s) to word(s) of memory depends on the size of the display space (the window size), the range of memory address accessed during the trace, a user specified zoom factor (the user can zoom in for more details), and an optional user specified block size (e.g., the user could ask to see if memory is cache page or disk page blocks).

As described or otherwise illustrated more fully herein, when an address is referenced, the corresponding pixel(s) can be color coded based on one of several alternative schemes. One scheme might use, for example, green for memory accesses by application instructions, blue for memory accesses for read operations, and red for memory accesses for data write operations. Another scheme could be used to encode address reference frequency into the color, so that warmer colors (red) indicate the most frequently accessed parts of memory. Yet another scheme could be used to encode information about cache faults or paging faults into the color. Still another scheme could be used to encode thread identifiers into a given color, which can be particularly valuable for multi-threaded programs.

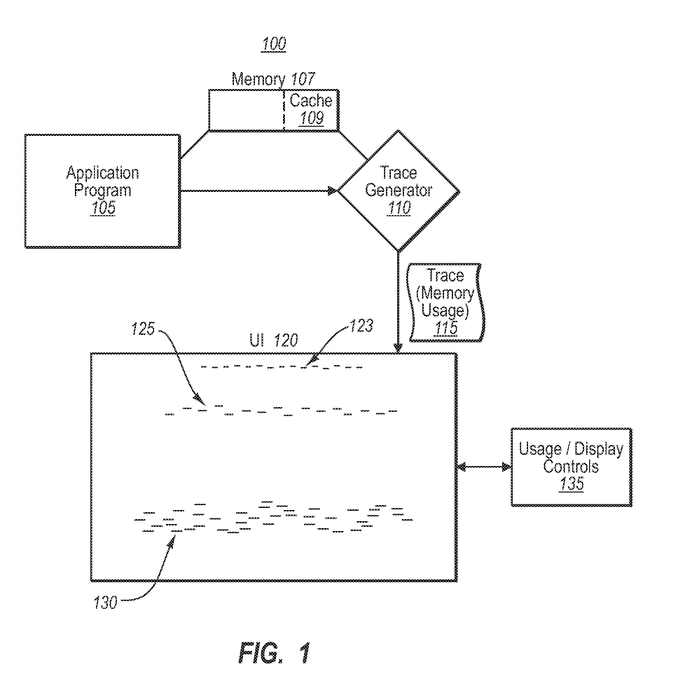

Referring now to the Figures, FIG. 1 illustrates an overview schematic diagram of a system 100 in which an application program's 105 memory access patterns are processed and displayed in display interface 120 as a visible, memory footprint. For example, FIG. 1 illustrates an application program 105, which may be any type or size of application program that would be loaded into a memory during execution, and thus access the memory in some way. In this example, application program 105 further contains one or more data access references, which reference data or functions in one or more memory 107 locations/addresses.

Any time a particular data reference is processed, the chunk of memory location corresponding to that data reference is cached into one or more of the cache 109 locations (e.g., L1, L2, etc.) Since it is faster to process data access requests from cache 109 rather than from the rest of the regular memory 107, it is preferable to cache (into cache 109) as many of the memory references that are going to be used, rather than caching them (into cache 109) on an as-needed basis. Accordingly, and to determine the efficiency with which these various data access requests are made, application program 105 is processed through trace generator 110.

In general, trace generator 110 is used to instrument the application program 105 over a particular time interval. In one implementation, a user that desires to instrument application program 105 might select an interval of five seconds, ten seconds, a few minutes, or even an hour or so, which represents some time during which the application program 105 executes one or more memory access requests in memory 107, whether it is read, write, or PC, etc. Trace generator 110 then identifies the specific memory address (and/or address range) of each of the different memory accesses, as well as any additional information during the time interval, such as the name of the function associated with the data access, the underlying program code, when the data access occurred, and so on. In one implementation, the trace can identify whether the location of the memory reference resulted in a “cache miss,” whereby a function executed from one cache 109 block resulted in a next function having to be pulled from main memory, rather than from the same or adjacent cache 109 block.

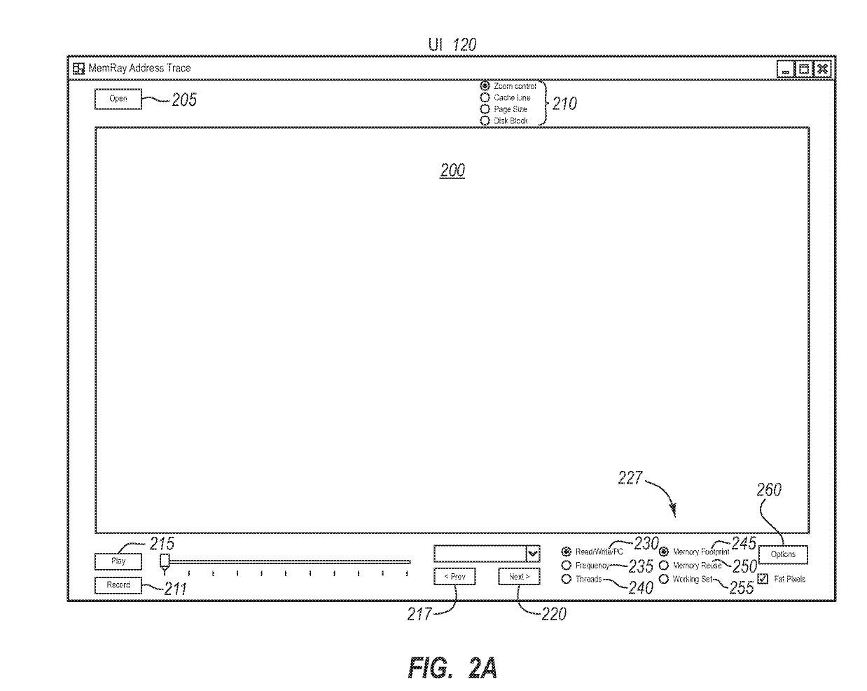

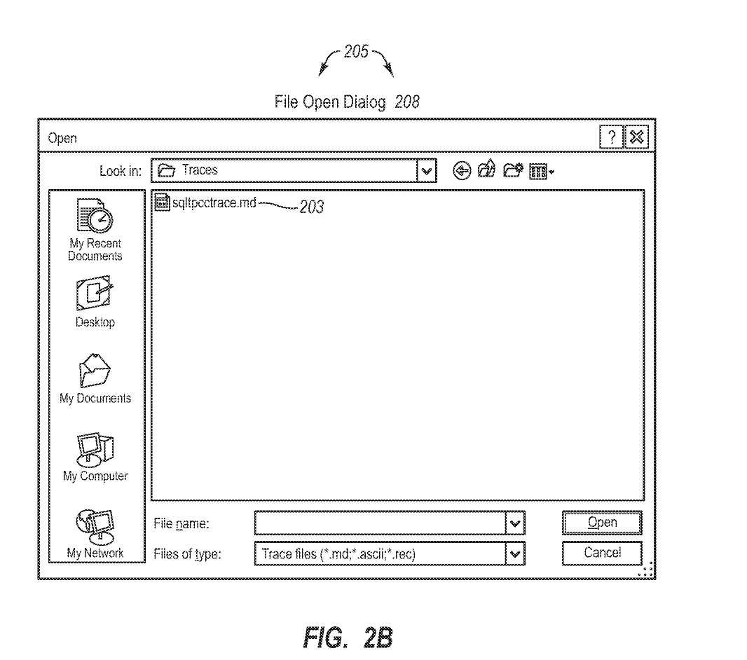

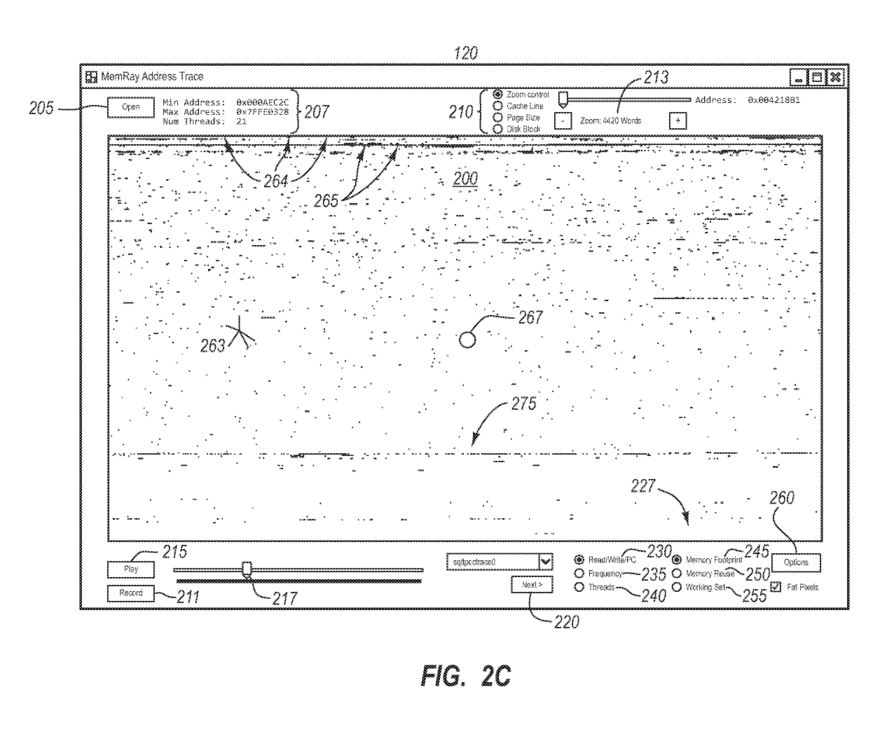

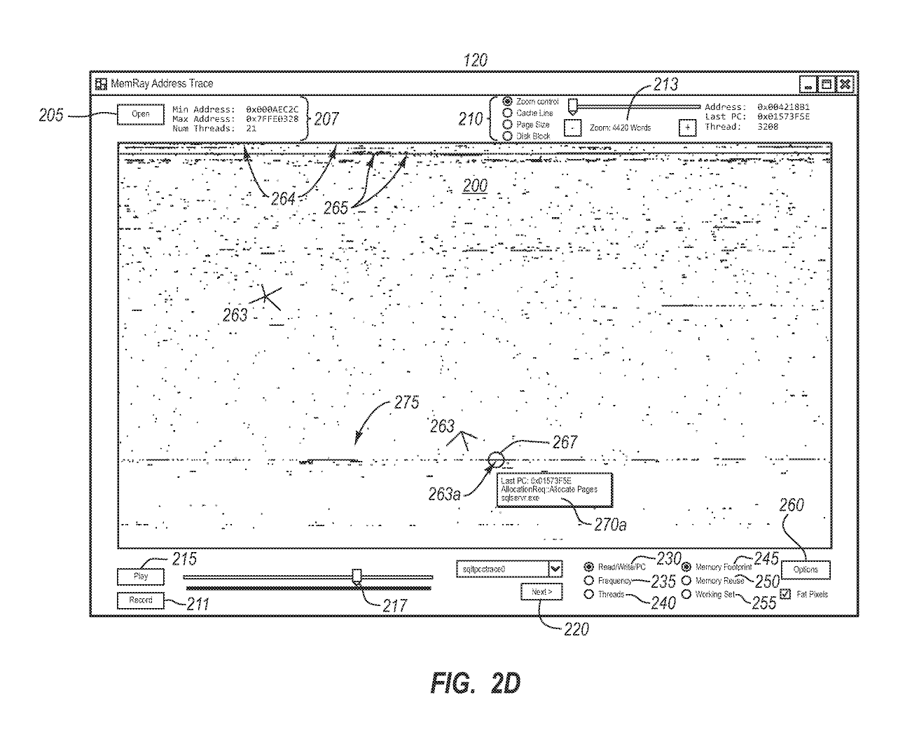

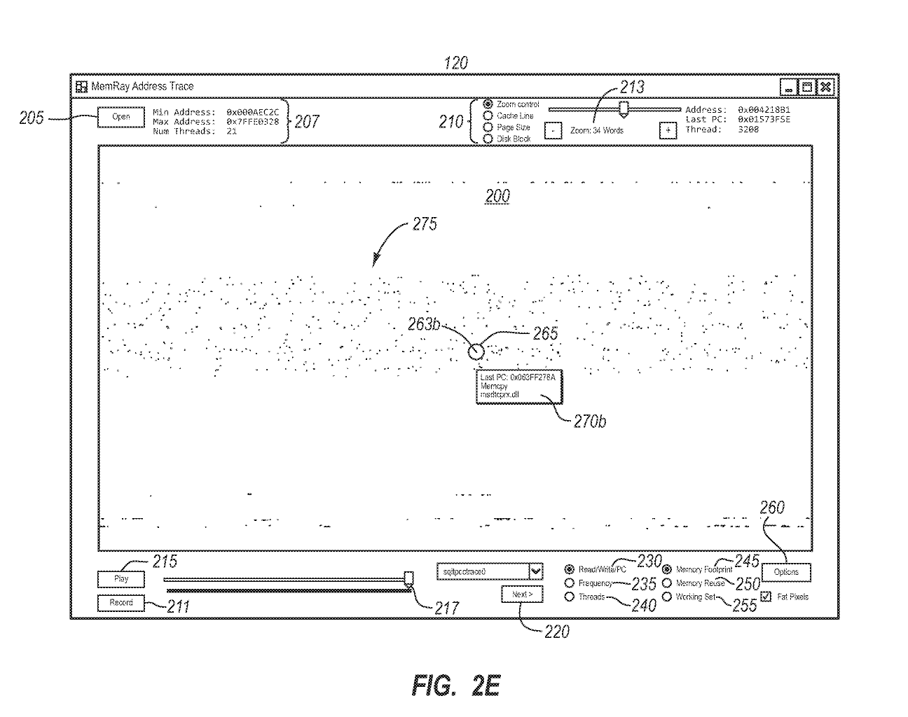

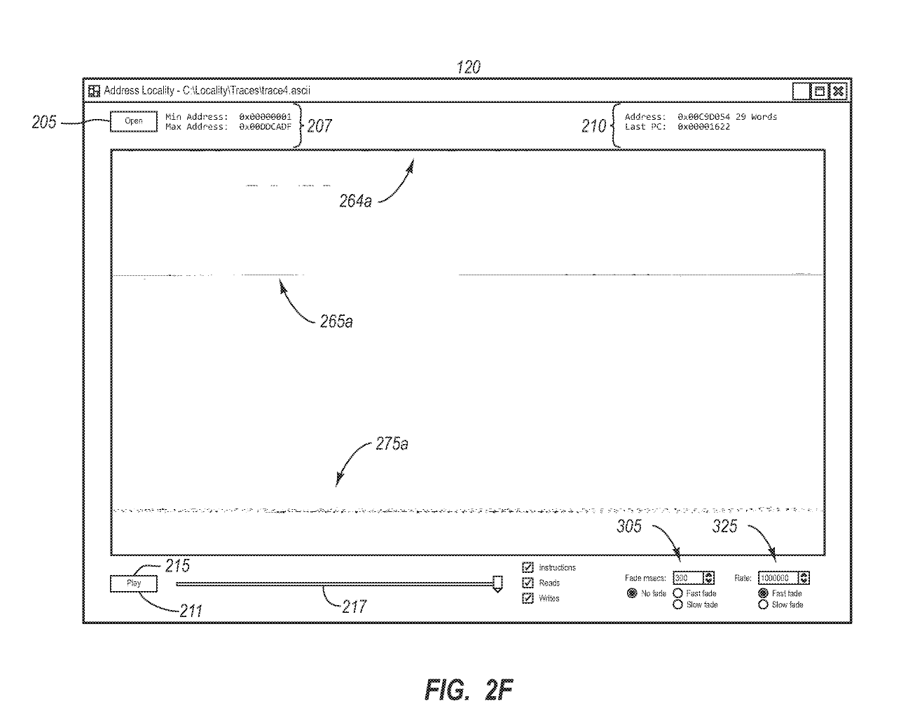

FIG. 1 further shows that system 100 comprises a memory footprint user interface 120 (or “user interface 120”). As will be shown and described more fully hereinafter, user interface 120 displays a visualization of the one or more traces 115 as a set of linear representations of different memory accesses over the selected time interval. In at least one implementation, these memory accesses in the address trace are represented as a set of memory address requests from application program instructions 123, memory address requests corresponding to the memory stack 125, and memory address requests corresponding to the memory heap 130. In other cases, additional or alternative lines might be found that relate to specific memory accesses executed by specific threads. In any event, and as will also be understood more fully herein, these representations can be varied widely for any number of preferences, and thus providing the user with a wide range of possible memory access visualizations. In general, these different preferences can be varied or otherwise implemented through a series of usage/display controls 135 (which include controls 205, 210, 211, 215, 217, 220, 227, etc. in FIGS. 2A-2F).

FIG. 2A illustrates at least one implementation of the memory footprint user interface 120 shown in FIG. 1. As shown, user interface 120 comprises one or more controls 205 for opening or otherwise importing a set of traces 115. In general, selection by the user of a given control 205 can cause the opening of a user interface dialog box, such as shown in FIG. 2B. For example, FIG. 2B shows that, upon selection of control 205, “file open” dialog box 208 is opened, which in this particular case reveals a set of previously-generated traces 203 (e.g., created using trace generator 110). Upon loading the one or more traces into user interface 120, the user can use any of the other different usage controls 135 to view the trace data access points through display window 200 of memory footprint user interface 120.

In general, the user will view the trace data access points through a display window 200 using a variety of different usage controls (e.g., 135). As shown again with respect to FIG. 2A, for example, the illustrated user interface 120 comprises display window 200, which displays the maximum and minimum addresses 207 of the given trace, and also a set of one or more memory controls 210. Display window 200 further displays a set of one or more playback controls 211, 215, 217 and 220, as well as a set of option controls 227. For example, FIG. 2A shows that option controls 227 comprise a read/write/program counter (or “PC”) option 230, a frequency option 235, a thread option 240, a memory footprint option 245, a memory reuse option 250 and a working set option 255. These various option controls 227 further comprise a set of additional filtering options 260, which are be described more fully hereinafter.

For example, selecting a read/write option 230 provides all the data access points that correspond to reads, writes, and/or PC. By contrast, selecting the frequency option 235 displays all the different memory accesses with various color codes, depending on how frequently those memory locations are accessed or referenced by the application program 105. Similarly, the threads option 240 can represent the memory accesses in a manner that is color-coded by thread, so that a user can view how the data access patterns might differ from one thread to another within the same application program. For example, an application program 105 comprising multiple threads could show the memory accesses in display window 200 as sets of blue colors for one thread and sets of red colors for another.

Similar filtering options are available for selecting memory footprint 205, memory reuse 250, and working set 255. For example, selecting memory footprint, which is a default, simply shows all memory accesses by all components of an application program as they occur. By contrast, selecting memory reuse 250 shows an animated playback of the memory references, fading each reference out relatively quickly so as to show a dynamic temporal view of how memory is being used. Selecting working set 255 shows a similar animated playback of memory references, but fades each reference out relatively slowly so as to show how the working set is changing over time.

Along these lines, FIG. 2C illustrates a memory footprint of application program 105 after a trace has been loaded. In this case, FIG. 2C shows the memory footprint when the read/write option 230 and memory footprint 245 have been selected. In general, each of the memory accesses (or groups thereof) are shown by a set of linear dashes or lines. For example, FIG. 2C shows that display window 200 shows a set of different memory accesses 263 scattered throughout the display window. In one implementation, the particular arrangement of a given data access 263 is based on a somewhat arbitrary placement of one or more anchoring (or extreme) memory address values, and then relative arrangement of the remaining memory accesses 263 there between by address location.

Thus, FIG. 2C illustrates that these memory accesses 263 are generally Z arranged throughout display window 200, however, memory accesses 263 also tend to aggregate into localized sets (e.g., as also shown in FIG. 1). As also shown in FIG. 1, for example, FIG. 2C shows that one set of memory accesses 263 generally form along a line 264, which represents memory accesses based on the set of application instructions, while another set of memory accesses 263 form a generalized line 265 representing memory accesses 263 in the memory stack. Furthermore, FIG. 2C shows that yet another set of memory accesses 263 form a generalized line (or set of lines), which may represent memory accesses 263 in memory heap 275.

Of course, these particular arrangements of memory accesses 263 may be different from one selected illustration to the next, and may mean different things depending on the selected trace. As previously mentioned, for example, the various aggregations of memory accesses 263 along specific lines can alternatively refer to memory accesses 263 corresponding to different application program 105 threads. In any event, the memory accesses of FIG. 2C, being scattered virtually throughout display window 200, suggest that the application program in this particular time interval has a rather large number of non-sequential memory accesses (not within the same generalized line/region). In this case, this is particularly problematic since the user interface 120 has only played back a first few set of intervals of the entire time interval for the selected trace.

For example, FIG. 2C shows that, upon selecting a “play” option of the playback controls 215, an interval selector 217 has begun to move along a time interval path. In one implementation, the interval selector 217 can move by default along the entire path, without stopping, to create an animated effect that illustrates some increasing density of memory accesses. In additional or alternative implementations, the interval selector 217 can also be paused at any moment in time to provide a display of the added samples up to that point. The playback controls 215 can further be used to record the animation (e.g., via record button 211) for subsequent, repeat viewing.

In any event, FIG. 2C shows that, in this particular example, interval selector 217 has moved only partly along the time interval path. In general, the position of the interval selector 217 dictates the number of sequential memory access samples that are added to produce a particular display in display window 200. In particular, the interval selector 217 can give the user the opportunity to identify particular time intervals (or time sub-intervals) during which the application program behaves poorly, or in an unintended manner.

For example, each sample (represented by each horizontal position of interval selector 217) may be based on a sampling rate of several hundreds, thousands, or even millions of the total access requests during the entire interval. One will appreciate, therefore, that the interval selector 217 can be configured to move as slowly or as quickly along the time interval path as desired based on part on the particular sampling rate. If a user selected a sampling rate of 100, the interval selector 217 might move quite slowly along the time interval path, while, a sampling rate of 10,000 would move the interval selector 217 quicker by a factor of 100.

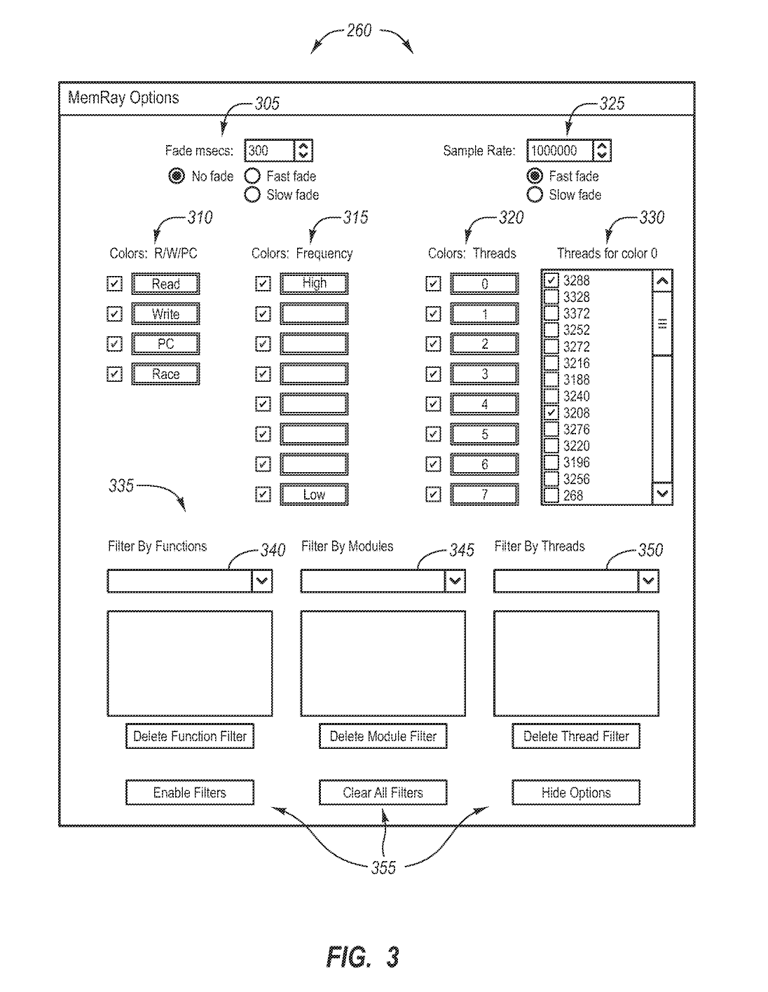

In either case, one will appreciate that a user may desire to adjust the sampling rate (e.g., FIG. 3) to watch how the memory accesses 263 occur over the entire time interval. For example, playback of the memory access animation might show that the memory accesses 263 generally form along a straight, confined path until some point along the time interval path in which the memory accesses 263 begin to distribute widely. This might then trigger the user to halt playback, and then look at specific memory accesses 263 more closely.

In one implementation, the user can adjust what is displayed (as well as the resolution of what is displayed) using the set of memory controls 210. For example, FIG. 2C shows inclusion of a zoom control, a cache line control, a page size control, and a disk block control. Selecting the zoom control illustrates the memory accesses 263 in terms of specific memory addresses included per pixel, while the “cache line” option, the “page size” option, and the “disk block” option provide still different variables that can be adjusted through zoom control 213. Zoom control thus provides for a variety of ranges of granularity in viewing data based on these particular options, and thus alters what is displayed. In each such case, and to get a better idea regarding the details of a particular memory accesses 263, a user can zoom in to a particular memory access request 263 using access selector 267, as well as zoom control 213. In one implementation, the zoom control 213 can also be controlled by using the mouse wheel, where rolling the wheel in one direction zooms in around the memory location identified by access selector 267, and rolling the mouse wheel in the opposite direction zooms out.

For example, FIG. 2C also shows in this example that each pixel of a memory access 263 corresponds to 4,420 words. Of course, this number of words per pixel can be adjusted upward or downward depending on the level of resolution that a user wants to see in display window 200. For example, a large number of words per pixel (e.g., 4,420) will provide an overview of the memory footprint or memory location of the application program, while a small number of words per pixel will allow a user to zero in on the details of a particular memory access 263. The effect of adjusting the zoom control is shown in more detail in FIG. 2E.

In any event, one will appreciate that the density of memory accesses 263 on display window 200 will increase as interval selector 217 moves along the interval selector path. For example, FIG. 2D illustrates display window 200 after more memory accesses 263 are added, which not only adds to the density of many accesses displayed in display window 200, but also begins to form more defined lines. In particular, FIG. 2D shows that lines 264, 265, and 275 have begun to become more defined. As with FIG. 1, these lines 264, 265, and 275 generally correspond in this particular example to memory accesses 263 corresponding to the application instructions, memory stack, and memory heap. As with FIG. 2C, however, FIG. 2D shows that there are many memory accesses 263 that are increasingly arranged throughout the display window 200. As previously mentioned, this wide distribution suggests that the memory references of application program 105 are poorly designed, as they are not well-localized to adjacent memory locations.

As previously mentioned in FIG. 2C, a user may desire to identify any commonalities among memory accesses 263 that do not fit along a relatively defined line such as the application instructions 264, memory stack 265, and/or heap 267. Accordingly, FIG. 2D illustrates an implementation of the present invention in which a user simply moves access selector 267 over a particular memory access to obtain more detailed data. In particular, FIG. 2D shows that access selector 267 is positioned over a range of memory accesses 263 to find specific memory access 263a.

In this example, the user identifies corresponding data 270a for this specific memory access request 263a which indicates the address of the last PC, the name of the method referencing this address (“Allocation Req::Allocate Pages”), and the application program for this request (“sqlserver.exe”). As a preliminary matter, reference herein to any components, functions, or modules that are specific (or appear to be specific) to a MICROSOFT operating environment is made primarily by way of convenience in explanation. In particular, one will appreciate that implementations of the present invention can be applied to a wide range of operating environments and operating systems. Accordingly, reference herein to any specific component or module should not be construed as limiting to any particular operating environment or operating system.

In any event, and with further respect to FIG. 2D, the user can move access selector 267 over any other access request 263 pixels for still different data. The user can also zoom in for better detail, such as upon focusing (e.g., positioning access selector 267 in a particular position) on a set of one or more memory access 263 pixels of interest.

For example, FIG. 2E illustrates one implementation of what can occur by changing the number of words per pixel. In particular, FIG. 2E shows that the user changes the memory controls 210 so that the zoom control 213 is at 34 words (rather than 4,420). Because, in this case, access selector 267 is positioned over the heap 275, FIG. 2E shows that the user is able to zoom in more closely on various memory accesses in the heap. In particular, FIG. 2E shows that access selector 265 is positioned more closely over a different memory access 263b. The indicia 270b corresponding to memory access 263b are different from those indicia 270a shown with memory access 263a (FIG. 2D). In particular, the indicia 270b show a different memory address for the last PC, that the program “memcpy” was used in this access request, and that the memory access 263b was based on a function presented “msdtcprx.dll.”

Accordingly, one will appreciate that a user can zoom further out or in the display window 200 to find memory footprint data at virtually any granularity. In at least one implementation, this ability to zoom inward and outward using zoom control 213 can be used regardless of the type of memory control 210 option selected. In particular, the changing of zoom by changing of words per pixel can be used during the default settings, as described above, as well as when “cache line,” “page size,” or “disk block” is selected.

Ultimately, one will appreciate that these and other controls of user interface 120 are specifically designed to enable a user to adjust the operation of a given application program. As previously mentioned, for example, a user can review the memory footprint and focus primarily on memory accesses 263 that fall significantly outside of the application instruction grouping 264, the memory stack grouping 265, or the memory heap grouping 275. In some cases, the user may even focus more narrowly on clusters of memory accesses 263 that fall outside of one of the expected groupings 263, 264, and 275. The intent of these adjustments would generally be to manipulate the corresponding code so that the memory accesses 263 would be located near other memory accesses of the same grouping, and thus more likely to be cached to cache at the same time as the other memory accesses.

Along these lines, FIG. 2F illustrates an example of a memory footprint that is displayed for an application that is well-written with respect to memory accesses for a given time interval. In particular, FIG. 2F shows that, in this case, the memory accesses are generally aggregated along well-defined lines. In particular, there is much less scattering and distribution of memory accesses 263 in FIG. 2F compared with the memory access 263 distribution in FIGS. 2C-2E.

As previously mentioned, FIGS. 2A-2F further show a set of additional, selectable option controls 227. As shown in FIG. 3, the selectable option controls (specifically filtering control 260), when selected, provide the user with a new filtering user interface 261 (or “filtering interface”). As also previously mentioned, the filtering interface 261 can allow a user to adjust or otherwise filter a number of features that add visible clarity to the data being displayed. For example, FIG. 3, shows that the user can select one or more fade controls 305. In general, the fade controls (when selected) cause a set of displayed memory access pixels to slowly fade away (e.g., to white), such that the memory accesses might bleed over into the next sample during playback.

In one implementation, the fade controls 305 are used with the “memory reuse” control 250 and the “working set” control 255. In this example, each block of pixels can be configured to fade to white from its designated color over a time interval. In general, the time interval can be set by the user, although two particular time intervals can work well in at least some implementations. In such an implementation, for example, if the fade out occurs over about one (1) second, the resulting view is a good indication of working set size over time. If the fade out is faster (about one-third (⅓) second), the resulting view shows more immediate memory reuse over time.

FIG. 3 also shows the filtering interface 261 can include a sample rate selector 325. As previously discussed, the sample rate selector 325 can be used to increase or decrease the playback speed by increasing the number of memory accesses (263) that are displayed per frame. One will appreciate, of course, that a high sample rate will result in fast playback, which can provide an overall sense of the memory footprint patterns during the time interval. By contrast, a low sample rate will result in slow playback, and further provide the opportunity to narrow in on particular problem areas.

In addition, FIG. 3 shows that the filtering interface 261 can include options to select one or more colors that are used with the option controls 227. For example, a user can select the read/write/PC options 230, which illustrates the memory accesses based on read, write, and/or PC memory during the time interval. In filtering interface 261, the user can also select one or more colors 310, so that reads are one color (e.g., blue), while writes are another color (e.g., red), program controls are yet another color (e.g., orange), and race conditions are still yet another color (e.g., green).

Similarly, the user can select one or more colors 315 corresponding to the frequency option 235. In this case, the animated playback through display window 200 would render the pixels based on the colors 315 chosen in interface 261, so that a user could easily distinguish frequent memory accesses from less frequent memory accesses. This could be yet another way in which a user can narrow in on problem areas, such as by focusing on the memory accesses that are both out of the generalized patterns, and also more frequent.

Furthermore, FIG. 3 shows that the user can choose a set of colors 320 for various different application program threads. In particular, FIG. 3 shows that a user can associate a number of different threads with a particular color. For example, filtering user interface 261 allows a user to first select color “0” (e.g., yellow) and then select all the different threads of the application program that should be associated with this color. Similarly, the user could associate another set of threads with the color “1” (e.g., brown), and so on.

In addition to the foregoing, FIG. 3 shows that the user can choose a number of additional filters 335 that indicate what should and should not be displayed in the memory footprint. For example, FIG. 3 shows that the user can filter the memory footprint by function that is making a particular memory access (regardless of whether it is read, write, PC, or even associated with a particular thread). For example, the user can pull down a functions menu 340 to select filtration by “AccBindings::ComputeProp,” “AcquireBulk TableLock,” or the like. Selection of any one or more of these functions means that the memory footprint shown in display window 200 would only show those memory accesses that were based on the selected functions.

Similarly, FIG. 3 shows that filtering user interface 261 provides one or more module filters, in which a user can pull down a modules menu item 345 to select filtration by “sqlservr.exe,” “opends60.dll,” and so on. As with menu 340, selection of any of the menu 345 items results in only those memory accesses corresponding to the selected modules being displayed in display window 200. Along these lines, FIG. 3 further shows that additional pull down menu items 350 are available for filtering by a specific thread, such that the display window only shows the memory accesses 263 that are based on the selected thread. Furthermore, FIG. 3 shows that the filtering interface 261 further includes a number of reset options 355, which generally allow a user to remove or reset any of the filtration selections from menus 340, 345, and 350. In particular, the user can hide and clear each of these different filters through a set of selectable filtering option modification icons 355.

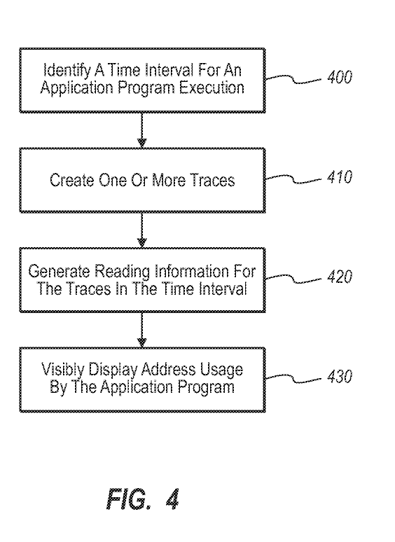

Accordingly, FIGS. 1-3 provide a number of different schematics, components, and user interface mechanisms for displaying a memory footprint of an application program. In particular, FIGS. 2A-2E illustrate how these tools can be used in the context of a poorly written application program, while FIG. 2F illustrates use of these tools with an application program that has fairly optimized memory accesses. In addition to the foregoing, implementations of the present invention can also be described in terms of flow charts comprising one or more methods having one or more acts for accomplishing a particular result. For example, FIG. 4 illustrates a flowchart of a method for visually representing a memory footprint of an application program. The acts in FIG. 4 are described below with respect to the components and diagrams of FIGS. 1-3.

For example, FIG. 4 shows that a method in accordance with an implementation of the present invention can comprise an act 400 of identifying a time interval for an application program execution. Act 400 includes identifying a time interval during which an application program executes a plurality of memory accesses. For example, a user selects several seconds, minutes or hours of a particular time interval, during which application program 105 executes various different memory references in memory module 107 and/or cache 109.

FIG. 4 also shows that the method can comprise an act 410 of creating one or more traces. Act 410 includes creating one or more address traces for the application program during the identified time interval. For example, the user instruments application program 105 with trace generator 110 to create a set of one or more address traces 115, 203. The one or more address traces 115 represent execution of the application program 105 during the selected time interval.

In addition, FIG. 4 shows that the method can comprise an act 420 of generating rendering information for the traces in the time interval. Act 420 includes generating pixel information corresponding to the memory accesses of the one or more address traces, wherein the memory accesses are displayed in accordance with the identified time interval. For example, a user retrieves the one or more traces 115 from trace generator 110, and passes the one or more traces 115 to user interface 120. User interface 120, in turn, renders the corresponding memory footprint through display window 200; and, in at least one implementation, displays the footprint in animated fashion. As shown in FIGS. 2A, 2C, 2D and 2E, for example, as the time interval selector 217 moves along a path, each different interval on that path results in the display of a different set of memory access 263 renderings for each, different time sub-intervals.

Furthermore, FIG. 4 shows that a method in accordance with the present invention can comprise an act 430 of visibly displaying address usage by the application program. Act 430 includes visibly displaying in a display window the pixel information in accordance with one or filtration selections by the user, wherein the display of pixels indicate a memory access footprint for the application program during the selected time interval. For example, FIGS. 1-2F show that memory accesses (e.g., 263) generally align along a set of lines that correspond to application program instructions (123, 264, 264a), a memory stack (125, 265, 265a), and a memory heap (130, 275, 275).

Accordingly, FIGS. 1-4 and the corresponding text illustrate or describe a number of different components, functions, and/or mechanisms for visibly displaying memory footprint information in a number of meaningful, useful ways. In particular, the features, components, and mechanisms described herein are particularly useful for showing dynamic memory access patterns, and enabling a user to optimize application programs to minimize speed bottlenecks that may occur through memory usage.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computerized environment that includes an application program configured to execute one or more memory accesses in a memory, a method of visually representing a memory footprint of the application program, wherein the memory footprint for the application program can be observed and optimized during a selected time interval, comprising the acts of:
identifying a time interval during which an application program executes a plurality of memory accesses;
creating one or more address traces for the application program during the identified time interval;
generating pixel information corresponding to the memory accesses of the one or more memory address traces, wherein the memory accesses are displayed in accordance with the identified time interval; and
visibly displaying in a display window the pixel information in accordance with one or more filtration selections by the user, wherein the display of pixels indicate a memory access footprint for the application program during the selected time interval.

2. The method as recited in 1, further comprising the acts of:
receiving one or more playback requests; and
rendering an animated sequence of the plurality of memory accesses during the selected time interval.

3. The method as recited in claim 2, further comprising the acts of:
receiving one or more sampling rate adjustment requests, wherein the one or more sampling rate adjustment requests change the number of memory accesses to be displayed per sample;
replaying the animated sequence with a change in replay speed.

4. The method as recited in claim 1, further comprising the acts of:
receiving one or more requests to highlight a specific set of one or more pixels; and
displaying one or more indicia corresponding to one or more memory accesses associated with the one or more pixels.

5. The method as recited in claim 4, wherein the one or more indicia include a function identifier, a module identifier, or an identifier of a thread associated with the application program.

6. The method as recited in claim 4, wherein the one or more requests to highlight include a request to color code the plurality of memory accesses based on instruction access, read access, write access, frequency of use, or thread identity.

7. The method as recited in claim 4, wherein the one or more requests to highlight include a request to fade any one of the plurality of memory accesses during an animation sequence playback.

8. The method as recited in claim 1, further comprising the acts of:
receiving one or more zoom adjustment requests, wherein the one or more zoom requests change the number of memory words per pixel;
generating new pixel information; and
visibly displaying the new pixel information in accordance with one or filtration selections by the user.

9. The method as recited in claim 1, wherein the one or more zoom adjustment requests change the number of memory words per pixel within a range of between about 1 memory word per pixel to about 5,000 memory words per pixel.

10. The method as recited in claim 1, further comprising an act of displaying for the one or more address traces a corresponding minimum and a maximum trace address in the display window.

11. In a computerized environment that includes an application program configured to execute one or more memory accesses in a memory, a computer program product having computer-executable instructions stored thereon that, when executed, cause one or more processors to execute and display a user interface configured to visually represent a memory footprint of the application program, the graphical user interface comprising:
a display window for viewing a memory footprint over a selected time interval;
a set of one or more memory controls configured to adjust the number of memory words, a range of the cache line, a page size, or a number of disk blocks displayed per sample;
a set of one or more playback controls configured to display a plurality of different application program execution samples during over the selected time interval; and
a plurality of selectable option controls configured to filter display of the application program execution during the selected time interval.

12. The user interface as recited in claim 11, further comprising a set of one or more receiving controls configured to enable opening or selection of one or more traces.

13. The user interface as recited in claim 11, further comprising a memory access selector which, when positioned over one or more displayed memory accesses, causes display of one or more indicia corresponding to the one or more displayed memory accesses.

14. The user interface as recited in claim 11, wherein the one or more selectable option controls comprise a read control, a write control, and/or a PC control, which, when selected, causes display only of the one or more memory accesses based on the selected read control, the write control, and/or the PC control.

15. The user interface as recited in claim 11, wherein the selectable option controls further comprise a frequency control, wherein selection thereof causes differential display of the one or more memory accesses based on frequency of memory address usage.

16. The user interface as recited in claim 11, wherein the selectable option controls further comprise a thread control, wherein selection thereof causes differential display of the one or more memory accesses based on one or more memory accesses by a specific application program thread.

17. The user interface as recited in claim 11, further comprising a filtering options control, wherein selection thereof displays a filtering interface configured to assign a plurality of different filters to any of the selectable option controls.

18. The user interface as recited in claim 17, wherein the plurality of different filters in the filtering interface comprise a fade control and a sampling control.

19. The user interface as recited in claim 17, wherein the plurality of different filters in the filtering interface comprise one or more options for assigning a different color to any of the selectable option controls, to a frequency value associated with the one or more memory accesses, and/or to one or more application program threads.

20. In a computerized environment that includes an application program configured to execute one or more memory accesses in a memory, a computer program storage product having computer-executable instructions stored thereon that, when executed, cause one or more processors in the computerized system to perform a method of displaying a memory footprint of an application program over a time interval, comprising:
identifying a time interval during which an application program executes a plurality of memory accesses;
creating one or more address traces for the application program during the identified time interval;
generating pixel information corresponding to the memory accesses of the one or more memory address traces, wherein the memory accesses are displayed in accordance with the identified time interval; and
visibly displaying in a display window the pixel information in accordance with one or more filtration selections by the user, wherein the display of pixels indicate a memory access footprint for the application program during the selected time interval.
